(19) United States
(12) Patent Application Publication
(10) Pub. No.: US 2008/0316002 A1
(43) Pub. Date: Dec. 25, 2008

(54) PRE-CONFIGURATION OF USER PREFERENCES

(76) Inventors: PETER T. BRUNET, Round Rock, TX (US); Anh Lu, Austin, TX (US); Lawrence F. Weiss, Round Rock, TX (US)

Correspondence Address: Greg Goshorn, P.C., 9600 Escarpment, Suite 745-9, AUSTIN, TX, 78749, US

(21) Appl. No.: 11/767,601

(22) Filed: Jun. 25, 2007

(51) Int. Cl. H04B 7/00

(52) U.S. Cl. 340/10.41

(57) ABSTRACT

Provided is a pre-configuration system and method for defining user configuration preferences for consumer devices and computer software and hardware at time of purchase and, then, automatically configuring the target devices when the device is packaged or first used. Information gathered in conjunction with the purchase of a target device is employed to determine the user configuration and then the user configuration is applied to the target device. A target device and associated hardware are imbedded with RFID tags thus enabling elimination of the configuration of a device by the end user. As a result, both user documentation and support calls are reduced. This is accomplished using RFID technology that enables labor free, automated transmittal of configuration data to the user device.

### TECHNICAL FIELD

The present invention relates generally to consumer product and computer setup and configuration and, more specifically, to a method for inferring and implementing a likely user configuration from information gathered during a purchase of a consumer device or computer.

### BACKGROUND OF THE INVENTION

Over the last several decades, computers have gone from being very expensive, custom-built devices to being available for purchase relatively cheaply in almost any electronic, department and discount retail outlet. Simultaneously, computers have become more powerful and typically loaded with large numbers of software applications and hardware devices. In addition, many consumer devices are now equipped with significant computing power.

Many computers now come loaded with a word processor, a graphics program, email and other communication programs, and so on. In addition, computers are often sold with a plethora of hardware such as a printer, scanner, facsimile device, wired and wireless communication devices, game controllers and so on. Typically, consumer devices and computers, including software and hardware sold in conjunction with a computer, require configuration prior to use. For example, many devices and applications require entry of such data as an owner's name and a time zone during an initial running of the program. Other information that may be required to establish a customized configuration for a consumer device and computer hardware and software may include such information as a preferred font type, text-to-speech conversion for a blind person, a display language, and so on.

One form of data storage and transfer that has not been utilized in conjunction with the configuration of hardware and software is radio frequency identification (RFID) technology. RFID technology typically includes a transponder, which stores a limited amount of information, and a processor or reader, which may read and perhaps write to the transponder. Transponders may be powered or unpowered, active or inactive and employ various means of data transmission, including inductive or propagation coupling. Information concerning RFID is available through the Automatic Identification Manufacturers, Inc. of Pittsburgh, Pa. at the website, <www.aimglobal.com> and the website <www.rfid.org>.

What is needed is a system and method for configuring multiple applications and devices at a single time, perhaps when a target device is shipped or purchased. Rather than requiring multiple configurations, a specially equipped terminal could collect configuration information at a single point in time and automatically load configuration information on the target device at that time. Also needed is a system and method for incorporating RFID technology into the configuration of applications and computing and consumer devices.

### SUMMARY OF THE INVENTION

Provided is a device and method for employing radio frequencies to store user configuration preferences of consumer devices and computer software and hardware at time of purchase and, then, automatically configure the target devices as the device is powered on. Information gathered in conjunction with the purchase of a target device is employed to infer a likely user configuration and then the likely configuration is stored in a radio frequency identification tag, or RFID, installed on the target device. Devices configured in accordance with the claimed subject matter include, but are not limited to, hardware, including peripherals, of a computing system and recoding media. Computing applications may also be configured in accordance with the claimed subject matter. For example, a user's name on a credit card is assumed to be the owner's name for the purpose of software and hardware configuration. The time zone in which the system is purchased is assumed to be the desired time zone setup for the system. At time of purchase, this information is loaded onto an RFID tag, which is shipped with the system, application or recording media.

In one embodiment, a graphical user interface (GUI) is employed at time of purchase to gather additional configuration information that cannot be inferred from purchase information. For example, a visually impaired person may have specific accessibility preferences such as a large default display font size or the enablement of a text-to-speech (TTS) feature of hardware and/or software so equipped. Other examples of TTS configuration information include, but are not limited to, a preferred gender and a specific speed rate for a synthesized voice.

In another embodiment of the disclosed technology, configuration corresponding to a target device and associated hardware are loaded on an RFID tag that enable the configuration to be implemented while the target device is enclosed within sales packaging. In other words, the target device does not need to be either removed from sales packaging or turned on for a particular configuration to be implemented. Configuration information is loaded into the RFID tag using a radio frequency configuration server (RFCS) and, when a user removes the target device from the packaging and turns it on, the device locates the RFID and, at that time, executes the necessary steps to configure the device. In addition, the RFID tag may be protected from unauthorized setting and reading. For example, a retractable Faraday cage may be slipped around the device and removed only when the setting and/or reading is appropriate. A kill signal may be employed to disable the device once the desired functionality has been performed.

In another embodiment, of the claimed subject matter, an RFID tag configured to implement user preferences is transportable from one device to another. For example, a user could download configuration preferences for a first computer or game controller to the claimed RFID tag and then connect the RFID tag to a second game controller or computer coupled to a second game controller and the downloaded preference is installed on the second device.

In another embodiment, the claimed RFID tag stores configuration information for multiple users. A particular user indicates, either actively or passively, their identity to the computer and the RFID tag provides configuration information for the device corresponding to the particular user's specifications. In this manner, a device such as a game controller is configured specifically for each particular user using the device.

In another embodiment, a media device, such as but not limited to, a digital video disk (DVD) includes RFID technology so that when the DVD is first played in a DVD player user preferences are preloaded. For example, a user may rent or purchase a DVD that comes pre-loaded with instructions to display subtitles in a particular language and to format playback using a particular aspect ratio.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures, in which:

FIG. 1 is a block diagram of a point-of-sale (POS) terminal, which includes a radio frequency configuration server (RFCS) and a computing system, which includes a radio frequency identification (RFID) tag, illustrating one possible implementation of the claimed subject matter.

FIG. 2 is a block diagram of a game controller, including an embedded RFID tag and the POS terminal of FIG. 1.

FIG. 3 is a block diagram of the RFCS of FIG. 1 in more detail.

FIG. 4 is a block diagram of the RFID tag of FIG. 1 in more detail.

FIG. 5 is a flowchart of a Sale process that incorporates the claimed subject matter.

FIG. 6 is a flowchart of a Gather Data process employed in conjunction with the claimed subject matter.

FIG. 7 is a flowchart of a Configure Device process employed to implement the claimed subject matter.

### DETAILED DESCRIPTION OF THE FIGURES

Although described with particular reference to personal computers (PC) and game controllers, the claimed subject matter can be implemented in any electronic device in which a simple and uniform configuration setup is desirable. In addition, the claimed subject matter may be implemented using other wireless communication media other than radio frequency identification (RFID) technology. Those with skill in the computing and communication arts will recognize that the disclosed embodiments have relevance to a wide variety of computing and communication environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor or PC.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also include, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for configuring an electronic device. The term “programmed method”, as used herein, is defined to mean one or more process steps that are presently performed; or, alternatively, one or more process steps enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

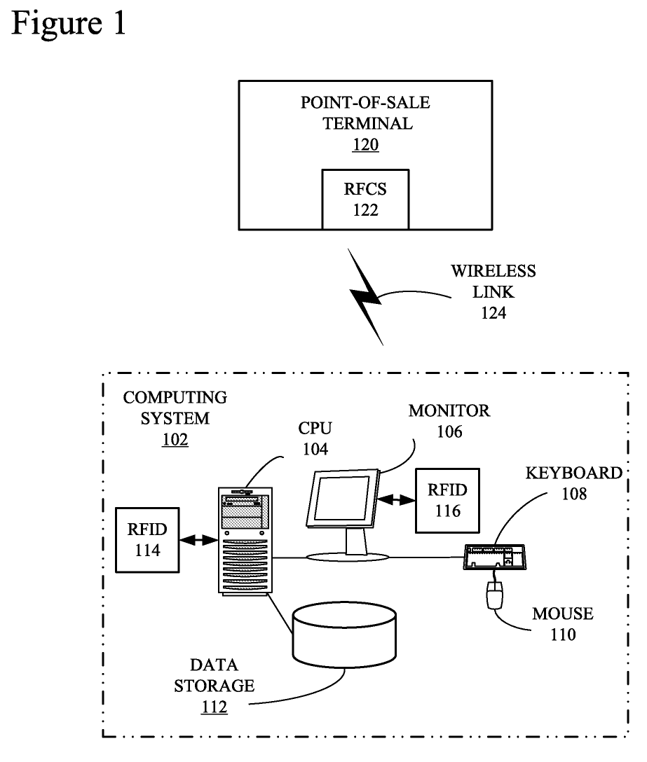

Turning now to the figures, FIG. 1 is a block diagram of a computing system 102, including a radio frequency identification tag (RFID) 114. FIG. 1 illustrates one possible implementation of the claimed subject matter. Computing system 102 includes a central processing unit (CPU) 104 coupled to a monitor 106, a keyboard 108 and a mouse 110, which together facilitate human interaction with computing system 102. Also included in computing system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown).

RFID tag 114 is coupled to CPU 104 and is able to receive radio frequency (RF) transmissions from a radio frequency configuration server (RFCS) 122. RFCS 122 is shown incorporated into a point-of-sale (POS) terminal 120, although RFCS could also be a stand-alone device. RFID tag 114 and RFCS 122 communicate via a wireless link 124. In the following examples, POS terminal 120 is a device that gathers information at the point of sale, such as, but not limited to, a cash register, and enables a consumer to complete a transaction. Terminal 120, like a typical POS terminal, scans product codes to arrive at a sales price, reads credit and debit cards, accepts cash payments and so on.

RFID tag 114 may be either attached externally or internally to CPU 104. If external, RFID tag 114 may be unattached from CPU 104 and employed on another device once the configuration of CPU 104 has been implemented. One possible technique for coupling RFID tag 114 is via an available communication port (not shown) on CPU 104. For example, RFID tag 114 may be configured to attach to a USB connection. In another embodiment, RFID tag 114 is simply affixed to CPU 104 and a reader (not shown) incorporated into CPU 104 so that RFID tag 114 may be scanned wirelessly.

Coupled to monitor 106 is RFID tag 116, which like RFID tag 114, may be internal or external to monitor 106 and, if external, may be uncoupled from monitor 106 and employed to configure another device. Like RFID tag 114, RFID tag 116 may be configured to attach to a communication port on monitor 106 or simply affixed to monitor 106 and scanned wirelessly.

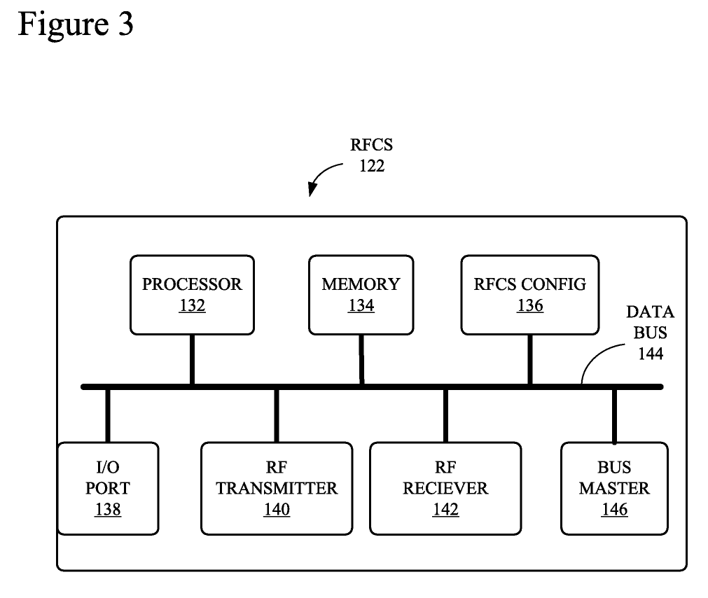

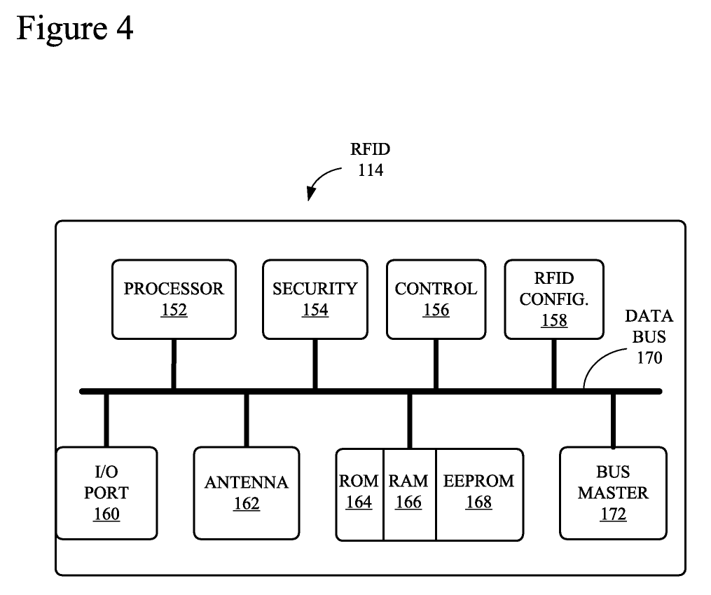

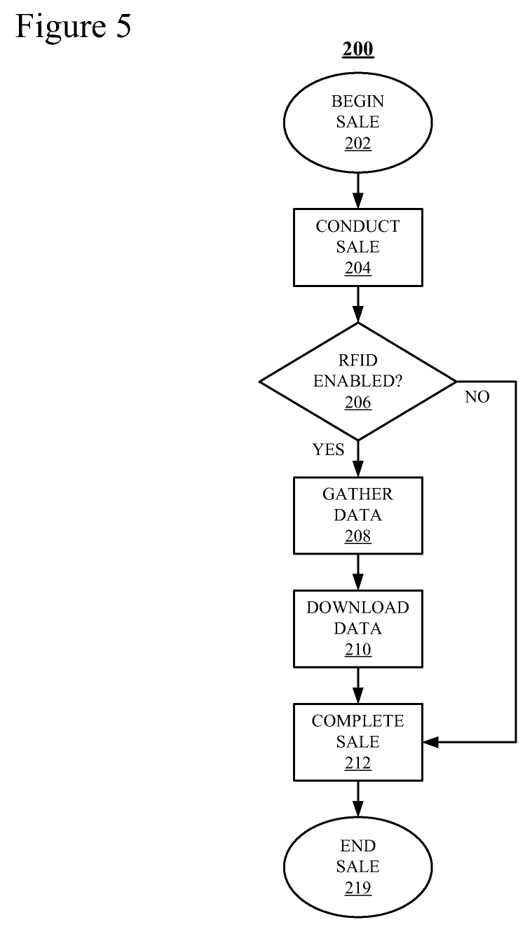

RFID tags 114 and 116 are typically coupled to their respective devices before computing system 102 is purchased and/or assembled. For example, CPU 104 and monitor 106 may be individual components on an assembly line of a business (not shown) that processes internet-based telephone orders for assembled systems. When the individual components such as CPU 104 and monitor 106 are packaged for shipment, the information gathered during the ordering process is employed to configure the components 104 and 106 using RFCS 122 and RFID tags 114 and 116. As explained below in conjunction with FIGS. 5-7, the actual configuration may take place either when information is gathered or when the device 104 or 106 is first powered up. RFCS 122 and RFID tag 114 are described in more detail below in conjunction with FIGS. 3 and 4, respectively, and the process of configuring components such as CPU 104 and monitor 106 is described in more detail below in conjunction with FIGS. 5-7.

In another example, CPU 104 and monitor 106 are stock items at an electronic retail outlet and the configuration of components 104 and 106 is implemented by RFID tags 114 and 116, respectively, at the time of purchase employing information gathered at the time of checkout. Those with skill in the computing and/or communication arts should appreciate that FIG. 1 is a simplified illustration of a computing system 102 and there may be many different scenarios in which the claimed subject matter may be utilized. The following figures are used for illustrative purposes only and there are many possible configurations and scenarios relevant to the disclosed technology.

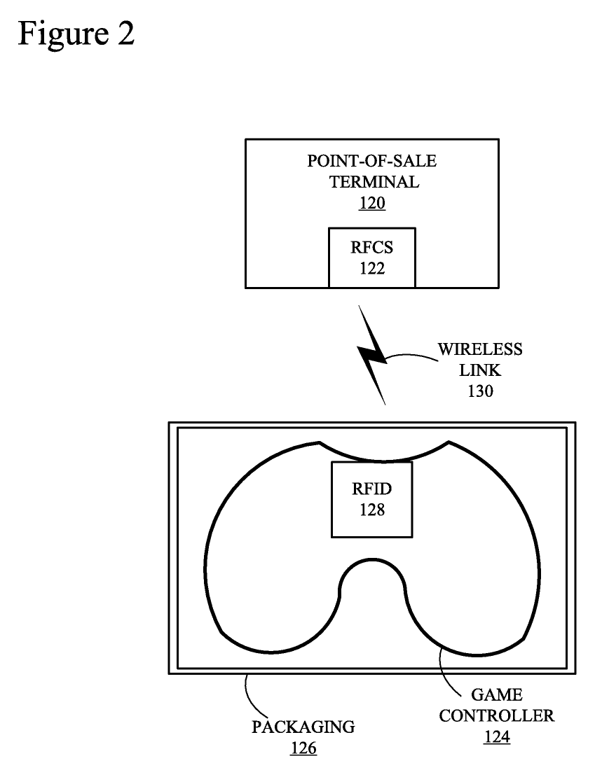

FIG. 2 is a block diagram of a game controller 124, including an embedded RFID tag 128, and point-of-sale (POS) terminal 120 (FIG. 1), including radio frequency configuration server (RFCS) 122 (FIG. 1), that together illustrate a second possible consumer that benefits from an implementation of the claimed subject matter. Of course, FIG. 2 is a simplified diagram of both game controller 124 and POS terminal 120 and merely introduced so that controller 124 and POS terminal 120 may be used in descriptions of the claimed subject matter in subsequent figures.

Specific details of controller 124 are not particularly relevant to the claimed subject matter and are therefore omitted for the sake of simplicity. In this example, controller 124 includes embedded RFID tag 128. RFID tag 128 receives signals from RFCS 122 via a wireless link 130. In this manner, configuration of controller 124 may be implemented at the time of sale even though controller 124 is encased in sales packaging 126.

Although RFID tag 128 is illustrated as embedded in controller 124, in the alternative, RFID tag 128 may be attached to an available communication port (not shown) and removed once controller 124 is configured and removed from packaging 126. In addition, if RFID tag 128 is detachable, RFID tag 128 may be detached from controller 124, attached to a second device (not shown) and then employed to configure the second device. The second device may be another game controller or another type of device altogether such as, but not limited to, computing system 102 (FIG. 1).

FIG. 3 is a block diagram of the RFCS 122 of FIGS. 1 and 2 in more detail. RFCS 122 includes a processor 132, a memory 134, an RFCS configuration (“config.”) module 136, an input/output (“I/O”) port 138, an RF Transmitter module 140, and an RF receiver module 142. Components 132, 134, 136, 138, 140 and 142 are each coupled to a data bus 144 that is controlled by a bus maser module 146. Although illustrated as individual components for the sake of clarity, a high degree of integration is possible. For example, components 132, 134, 136, 138, 140, 142, 144 and 146 may be integrated and manufactured in a cost efficient manner on a single chip.

Processor 132 executes logic to implement the claimed subject matter using configuration information, various temporary parameters and parameters associated with the target device, which in this case is computing system 102 (FIG. 2), stored on memory 134. In other words, memory 134 is volatile memory employed by processor 132 to execute the disclosed logic.

RFCS configuration module 136 is non-volatile memory that stores the logic and parameters necessary to implement the claimed subject matter. Information stored in module 136 includes information relating to whether RFCS 122 is configured as a server and the associated logic to implement the particular configuration. Additional information stored in module 136 relates to the various types of devices with which module 136 might communicate. Such information enables module 136 to format configuration commands specifically directed to the various device.

I/O port 138 handles communication between RFCS 122 and a device to which RFCS 122 is coupled, or in this example POS terminal 120 (FIGS. 1 and 2). Communication includes relevant information collected by POS terminal 120 for the configuration process according to the disclosed technology. Such a connection typically requires a direct connection such as, but not limited to, complementary plug-in receptacles (not shown) on RFCS 122 and POS terminal 120.

RF transmitter module 140 establishes a connection to a corresponding RFID tag such as RFID tag 114 (FIG. 1), RFID tag 116 (FIG. 1) or RFID tag 128 (FIG. 2). The communication between RFCS 122 and RFID tags 114, 116 and 128 is described in more detail below in conjunction with FIGS. 5-7. RF receiver module 142 receives data transmitted to the RFCS such as from RFID tags 114, 116 and 128. Data includes, but is not limited to, information regarding the type of device associated with the RFID tag and acknowledgement signals to indicate successful completions of data transfer and possibly configuration operations.

FIG. 4 is a block diagram of the RFID tag 114 of FIG. 1 in more detail. RFID tag 114 includes a processor 152, security logic 154, control logic 156, an RFID configuration (“config.”) module 158, an input/output (“I/O”) port 160, an antenna 162, various types of memory, including a read-only memory (ROM) 164, a random access memory (RAM) 166 and an electrically erasable programmable read only memory (EEPROM) 168. Components 152, 154, 156, 158, 160, 162, 164, 166 and 168 are each coupled to a data bus 170 that is controlled by a bus maser module 172. Although illustrated as individual components for the sake of clarity, a high degree of integration is possible. For example, components 152, 154, 156, 158, 160, 162, 164, 166 and 168 may be integrated and manufactured in a cost efficient manner on a single chip.

Processor 152 executes logic to implement the claimed subject matter using configuration information and various parameters associated with the target device, which in this case is computing system 102 (FIG. 1), stored in components 156, 158, 164 and 168. Security module 154 controls access to RFID 114, thus preventing unauthorized access to information stored in RFID 114, including information such as, but not limited to, user information and configuration parameters. Module 154 may be used in addition to or in conjunction with other means to prevent unauthorized access and/or setting of RFID 114. For example, a retractable Faraday cage (not shown) may be installed on RFID 114 and removed only in appropriate circumstances for either the setting or reading of RFID 114. This capability provides protection to a user's privacy.

RAM 166 is volatile memory employed by processor 152 to execute the disclosed logic. RFID configuration module 158 is non-volatile memory that stores the logic and some parameters necessary to implement the claimed subject matter. Types of information stored by module 158 include information relating to configuration options and procedures of the target device computing system 102 and logic related to the operation of RFID tag 114 as a target device.

I/O port 160 handles communication between RFID tag 114 and a device to which RFID tag 114 is coupled, or in this example computing system 102. Antenna 162 enables RFID tag 114 to send and receive data to and from RFCS 122 (FIGS. 1 and 2), which is coupled to a data collection device such as POS terminal 120 (FIGS. 1 and 2) that gathers information at the point of sale. One example of information transmitted to RFCS 122 includes information regarding the target device or an acknowledgement signal indicating that a requested configuration is successful.

FIG. 5 is a flowchart of a Sale process 200 that incorporates the claimed subject matter. This example involves an implementation of the claimed subject matter at a point of sale in a store such as an electronic retail outlet. In this example, process 200 is executed by POS terminal 120 (FIGS. 1 and 2) or some other device that typically executes a retail sale. As noted above, the claimed subject matter is also applicable to a wide variety of situations including, but not limited to, mail order, Internet or telephone based delivery operations. In each case, a modified process similar to process 200 and tailored to the particular situation would be employed.

Process 200 starts in a “Begin Sale” block 202 and proceeds immediately to a “Conduct Sale” block 204. During block 204, a retail electronic outlet conducts the sale of an item such as, in this example, computing system 102 (FIG. 1). During a “RFID Enabled?” block 206, process 200 determines whether or not the item that is the subject of the sale is a device that employs an RFID tag configured in accordance with the claimed subject matter such as RFID tags 114, 116 and 128 and if the device is enabled. As explained above in conjunction with FIG. 4, RFID 114 may be shielded from unauthorized access and reading by means of a device such as a retractable Faraday cage. In that case, the shielding device would need to be removed or disabled to make RFID 114 available. This determination is made by whether or not RFCS 122 (FIGS. 1 and 2) detects the presence of a suitable RFID tag such as tags 114, 116 or 128. It should be noted that more than one RFID tag may be detected. One method for the detection of an RFID tag device involves a “ping” on an available channel, either a wire or wireless connection, depending upon what the configuration of RFCS 122 and RFID tags 114, 116 or 128. A wired ping would be transmitted via I/O port 138 (FIG. 3) and a wireless ping would be transmitted by RF transmitter 140 (FIG. 3). A reply ping would be received either on I/O port 138 or RF receiver module 142, depending upon the source of the original ping from RFCS 122.

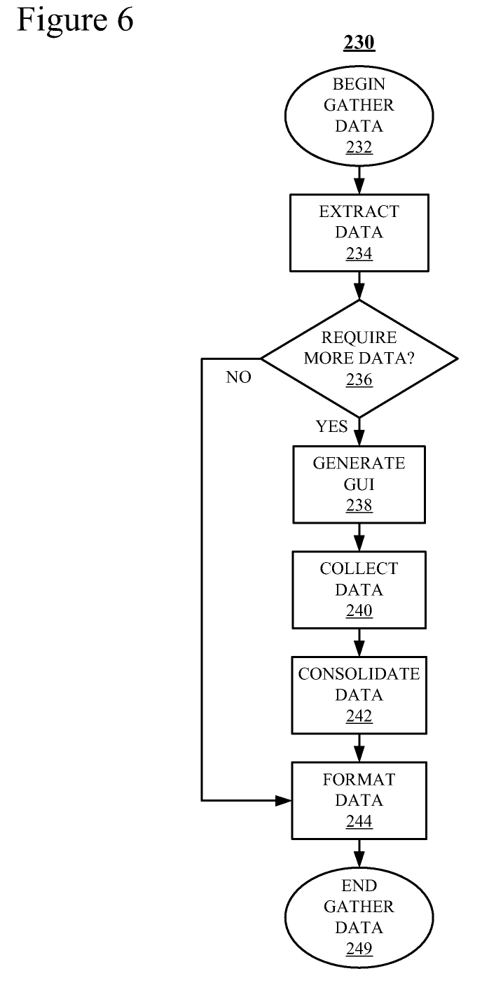

If an RFID tag or tags are detected, process 200 proceeds to a “Gather Data” block 208 during which information related to the detected device or devices is collected or gathered. Gather Data block 208 is described in more detail below in conjunction with FIG. 6. During a “Download Data” block 210, the data gather during block 208 is transmitted to the one or more RFID tags detected during block 206.

Once blocks 208 and 210 have executed or if process 200 determines that the purchased item is not RFID tag enabled during block 206, control proceeds to a “Complete Sale” block 212. During block 212, POS terminal 120 is used like a typical POS terminal to complete the sale of the purchased item. Process 200 then proceeds to an “End Sale” block 219 in which process 200 is complete.

FIG. 6 is a flowchart of a Gather Data 230 process employed in conjunction with the claimed subject matter. Process 230 is stored in RFCS Configuration module 136 (FIG. 3), loaded into memory 134 (FIG. 3) and executed on process 132 (FIG. 3). In the following example, computer system 102 (FIG. 1) is purchased at POS terminal 120 (FIG. 1). Gather Data process 230 corresponds partially to Gather Data block 208 of Sale process 200, described above in conjunction with FIG. 5.

Process 230 starts in a “Begin Gather Data” block 232 and proceeds immediately to an “Extract Data” block 234. During block 234, process 230 queries POS terminal 120 for information related to the current sale. Examples of information include, but are not limited to, the name and address of the consumer making the purchase. Other data that can be retrieved from POS terminal 120 itself are the date and time of the purchase and the time zone in which the purchase is made.

As mentioned above in conjunction with FIG. 5, prior to the execution of process 230 during RFID Enabled? block 206 (FIG. 5), RFCS 122 determines whether or not there is one or more RFID tags configured according to the claimed subject matter by pinging available communication channels. A reply ping not only verifies the existence of an RFID enabled, or target, device but also includes information relating to the type of the target device. In this manner, RFCS 122 is able to tailor a configuration message, using data stored in RFCS Configuration module 136 (FIG. 3), specifically for the target device or devices.

During a “Require More Data?” block 236, process 230 determines whether or not the data gathered during block 234 is sufficient to create a configuration for the target device or devices. If more data is required or even merely desirable, process 230 proceeds to a “Generate GUI” block 238. During block 238, process 230 generates a GUI on POS terminal 120 that enable the consumer to be queried about additional information necessary to configure the targeted devices. For example, the consumer may be asked the size of display font that is most comfortable to use. In another example, a visually impaired person may be queried concerning specific accessibility preferences such as a large default display font size or the enablement of a text-to-speech (TTS) feature of hardware and/or software so equipped. Other examples of TTS configuration information include, but are not limited to, data as a preferred gender and a specific speed rate for a synthesized voice. Those with skill in the computing arts should appreciate the types of information that would be desirable to configure the target device.

During a “Collect Data” block 240, process 230 gathers the data entered into the GUI generated during block 238. During a “Consolidate Data” block 242 the data gathered during block 240 is integrated with the date gathered during block 234.

At the completion of block 242 or, if during block 236, process 230 determines that more data is not required, control proceeds to a “Format Data” block 244. During block 244, the data consolidated during block 242 are formatted into a configuration message for the target device or devices. Finally, process 230 proceeds to an “End Gather Data” block 249 in which process 230 is complete.

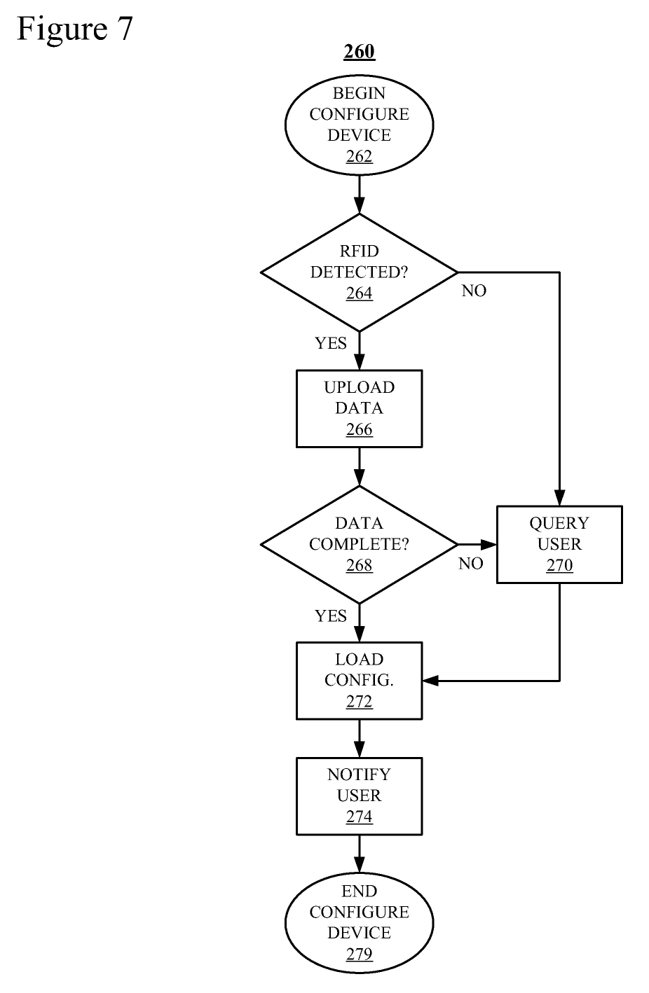

FIG. 7 is a flowchart of a Configure Device 260 process employed in conjunction with the claimed subject matter. Process 260 is stored and executed either in a device configured in accordance with the claimed subject matter, such as CPU 104 (FIG. 1) or a device (not shown) configured to playback a device, such as a media playback device, configured to play a DVD or other media device, equipped in accordance with the claimed subject matter. Process 260 is typically executed either concurrently with Sale process 200 (FIG. 5) or when the target device is first powered on for the first use.

Process 260 starts in a “Begin Configure Device” block 262 and proceeds immediately to a “RFID Detected?” block 264. During block 264, the target device, which in this example is CPU 104 (FIG. 1), determines whether or not an RFID tag programmed in accordance with the claimed subject matter is present. Such a determination may be ascertained by either pinging, in this case, RFID tag 114 (FIG. 1) or assumed based upon a previous configuration of CPU 104. It should be noted that although described with respect to CPU 104 and RFID tag 114 other configurations of devices would also benefit from the claimed subject matter. For example, an RFID tag may be incorporated into a DVD or any other type of physical media for the storage of digital content. In that case, the processing associated with FIG. 7 is executed by a DVD player (not shown) when a DVD suitably equipped is inserted for playback. In this manner, the DVD player is able to configure the playback of the DVD as determined by the user based upon information stored in conjunction with the DVD. It should be noted that a tag incorporated into a DVD or another type of physical media may incorporate information such as, but not limited to, playback restrictions associated with the media.

If an RFID tag is detected, process 260 proceeds to an “Upload Data” block during which the device in the process of being configured, in this example CPU 104, retrieves the data downloaded to the RFID tag, in this example RFID tag 114, during block 210 (FIG. 5) of process 200 (FIG. 5). During a “Data Complete?” block 268, process 260 determines whether or not the data uploaded during block 266 is sufficient for a configuration of the target device. If not, or if an RFID tag is not detected during block 264, process 270 proceeds to a “Query User” block 270 during which a user is queried to select any necessary configuration options.

During a “Load Configuration” block 272, process 260 configures the target device in accordance with any configuration options selected during block 270 and any options uploaded during block 266. During a “Notify User” block 274, the target device notifies the user that the configuration of the target device is configured and ready for use. This notification may either be explicit, i.e. a message is displayed, of implicit, the device begins standard operation in the selected configuration. In addition, at this point, steps may be taken to disable RFID 114. For example, a kill signal may be transmitted to RFID 114 that causes RFID 114 to erase all stored configuration data to protect the user's privacy. Finally, process 260 proceeds to an “End Configure Device” block 279 in which process 260 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for automatically setting a configuration parameter in a device, comprising:
collecting configuration information from a user;
transforming the collected information into a configuration parameter corresponding to the device;
storing the configuration parameter in a radio frequency identification (RFID) tag coupled to the device;
reading the configuration parameter from the RFID tag upon power up of the device; and,
configuring the device based upon the stored configuration parameter.

2. The method of claim 1, wherein the device is a computer and the configuration information is collected at a point of sale by a point of sale terminal.

3. The method of claim 1, wherein the configuration parameter corresponds to an accessibility preference.

4. The method of claim 1, wherein the RFID tag is embedded in a physical media rather than coupled to the device and the device uploads the configuration parameter from the RFID tag to control playback of the physical media on the device.

5. The method of claim 4, wherein the configuration parameter corresponds to playback restrictions associated with content stored on the physical media.

6. The method of claim 1, wherein the configuration parameter corresponds to a language for audio and display playback.

7. The method of claim 1, further comprising securing the RFID tag from unauthorized disclosure and setting of the stored configuration parameter.

8. The method of claim 1, wherein the RFID tag is incorporated into packaging associated with the device.

9. A system for automatically setting a configuration parameter in a device, comprising:
a radio frequency identification (RFID) tag;
logic for collecting configuration information from a user;
logic for transforming the collected information into a configuration parameter corresponding to a device;
logic for storing the configuration parameter in the RFID tag;
logic for uploading the configuration parameter from the RFID tag to the device upon power up of the device; and,
logic for configuring the device based upon the uploaded configuration parameter.

10. The system of claim 9, wherein the device is a computer and the configuration information is collected at a point of sale by a point of sale terminal.

11. The system of claim 9, wherein the configuration parameter corresponds to an accessibility preference.

12. The system of claim 9, wherein the RFID tag is embedded in physical media and the device is a playback device for playing content stored on the physical media.

13. The system of claim 12, wherein the configuration parameter corresponds to playback restrictions associated with the content stored on the physical media.

14. The system of claim 9, wherein the RFID tag is incorporated into packaging associated with the device.

15. A computer programming product for automatically setting a configuration parameter in a device, comprising:
a memory;
logic, stored on the memory for execution on a first processor, for collecting configuration information from a user;
logic, stored on the memory for execution on the first processor, for transforming the collected information into a configuration parameter corresponding to the device;
logic, stored on the memory for execution on the first processor, for storing the configuration parameter in a radio frequency identification (RFID) tag coupled to the device; and
logic, stored on the memory for execution on a second processor coupled to the device, for uploading the configuration parameter from the RFID tag to the device upon power up of the device.

16. The computer programming product of claim 15, wherein the device is a computer and the configuration information is collected at a point of sale by a point of sale terminal.

17. The computer programming product of claim 15, wherein the configuration parameter corresponds to an accessibility preference.

18. The method of claim 15, wherein the RFID tag is embedded in a physical media rather than coupled to the device and the configuration parameter controls playback by the device of content stored on the physical media.

19. The computer programming product of claim 18, wherein the configuration parameter corresponds to playback restrictions associated with the content stored on the physical media.

20. The computer programming product of claim 15, wherein the RFID tag is incorporated into packaging associated with the device.
